(19) United States
(12) Patent Application Publication
(10) Pub. No.: US 2025/0112706 A1
(43) Pub. Date: Apr. 3, 2025

(54) COHERENT DETECTION OF SUBCARRIER-MULTIPLEXED SIGNALS USINGA FREQUENCY COMB

(71) Applicant: Nokia Solutions and Networks Oy, Espoo (FI)

(72) Inventor: Di Che, Union, NJ (US)

(21) Appl. No.: 18/476,982

(22) Filed: Sep. 28, 2023

(51) Int. Cl. H04B 10/61

(52) U.S. Cl. CPC H04B 10/6166

(57) ABSTRACT

An optical data receiver is configured for receiving optical signal comprising spectrally adjacent modulated subcarriers. The optical receiver includes an optical comb generator to output separate frequency tones, and a plurality of optical-to-electrical (OE) converters. The OE converters are configured to mix light of a plurality of the frequency tones with part of the received optical signal, and to output a temporal sequence of measurements of the mixture produced by said mixing. A digital signal processor is configured to recover a data stream carried by one of the subcarriers by performing multi-input multi-output (MIMO) processing using the temporal sequences of measurements output by at least two of the OE converters. The MIMO processing involves performing passband filtering for a passband wherein two of the subcarriers are down-converted by the mixing.

### TECHNICAL FIELD

The present disclosure generally relates to optical communications, and more particularly relates to optical receivers for high data rate optical signals.

### BACKGROUND

Modern broad-band optical communication systems typically use wavelength division multiplexing (WDM) at a transmitter site and optical coherent detection at a receiver site. Conventionally a “colored”, i.e. wavelength-dependent optical receiver is used, with a wavelength de-multiplexer (DEMUX) and a local oscillator (LO) laser that is aligned in frequency to the optical transmitter laser of a particular WDM channel. Such a “colored” receiver typically requires a precise wavelength control for both transmitter and receiver lasers, which increases both the laser cost and energy consumption for cooling and temperature-stabilization of all the wavelength-dependent components in the coherent system. The power consumption issue complicates the dense deployment of coherent systems in datacenters. Wavelength alignment and stabilization requirements at both the optical receiver and transmitter site may be lessened by using an optical frequency comb generator as the optical LO source at the coherent optical receiver. Demodulating a broad-band optical signal using an optical frequency comb as a local oscillator typically requires digital spectral stitching of spectral slices.

### SUMMARY

An aspect of the present disclosure provides an apparatus including an optical data receiver. The optical data receiver is configured for receiving an optical signal comprising spectrally adjacent modulated subcarriers. The optical data receiver includes an optical comb generator to output separate frequency tones, and a plurality of optical-to-electrical (OE) converters. Each of the OE converters is configured to mix light of a plurality of the frequency tones with a part of the received optical signal, and to output a temporal sequence of measurements of a mixture produced by said mixing. A digital signal processor is configured to recover a data stream carried by one of the subcarriers by performing multi-input multi-output (MIMO) processing using the temporal sequences of measurements output by at least two of the OE converters. The MIMO processing involves performing passband filtering for a passband wherein two of the subcarriers are down-converted by the mixing. In some embodiments, the MIMO processing includes performing passband filtering for a plurality of adjacent passbands, into which different subsets of the modulated subcarriers are down-converted by the mixing, and parallel MIMO equalization to separately demodulate data streams carried by the different subsets of the modulated subcarriers using the measurements of two or more of the OE converters.

### BRIEF DESCRIPTION OF THE DRAWINGS

Embodiments disclosed herein will be described in greater detail with reference to the accompanying drawings which represent example embodiments thereof, in which like elements are indicated with like reference numerals, and wherein:

FIG. 1 is a schematic block diagram of a colorless optical data receiver for subcarrier-modulated (SCM) optical signals according to an embodiment;

FIG. 2A is a schematic diagram illustrating a symmetric alignment of a received signal spectrum and an optical frequency comb spectrum at the optical data receiver of FIG. 1, with the center of the received signal spectrum aligned with the mid-point between two frequency tones of the comb;

FIG. 2B is a schematic diagram illustrating the spectra of down-converted products of mixing the received signal with different frequency tones of the frequency comb for the symmetric alignment of FIG. 2A;

FIG. 3A is a schematic diagram illustrating an example offset alignment of the received signal spectrum and the optical frequency comb, with the center of the received signal spectrum offset by 1.2 subcarrier spacing from the symmetric alignment of FIG. 2A;

FIG. 3B is a schematic diagram illustrating the spectra of down-converted beat products of mixing the received signal with the different frequency tones of the OCG comb for the offset alignment of FIG. 3A;

FIG. 4 is a flowchart illustrating various signal processing operations to extract subcarrier data streams by MIMO processing of outputs of the OE converters of the optical data receiver of FIG. 1;

FIG. 5 is a schematic diagram of the spectrum of an optical SCM signal with inter-subcarrier gaps, which may be used in the system of FIG. 1;

FIG. 6 is a schematic block diagram of a transceiver including an embodiment of the optical data receiver of FIG. 1.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits may be omitted so as not to obscure the description of the present invention. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future.

Note that as used herein, the terms “first”, “second” and so forth are not intended to imply sequential ordering, but rather are intended to distinguish one element from another, unless explicitly stated. Similarly, sequential ordering of method steps does not imply a requirement of sequential order of their execution, unless explicitly stated. The term “connected” may encompass direct connections or indirect connections through intermediate elements, unless explicitly stated otherwise.

The following abbreviations and acronyms may be used in the present document:

ASIC: application specific integrated circuit

BWL: bandwidth limit

DC: direct current (the zero frequency)

DD: direct detection

DEMUX: demultiplexer

DP: dual polarization

DSP: digital signal processor

IM: intensity modulation

LO: local oscillator

MIMO: multi-input multi-output

Rx: receiver

SCM: subcarrier multiplexing

Tx: transmitter

WDM: wavelength division multiplexing

WSS: wavelength selective switch

Various embodiments described below relate to an apparatus, and a corresponding method, in which subcarrier-multiplexed optical signals are coherently detected using an optical frequency comb as a reference.

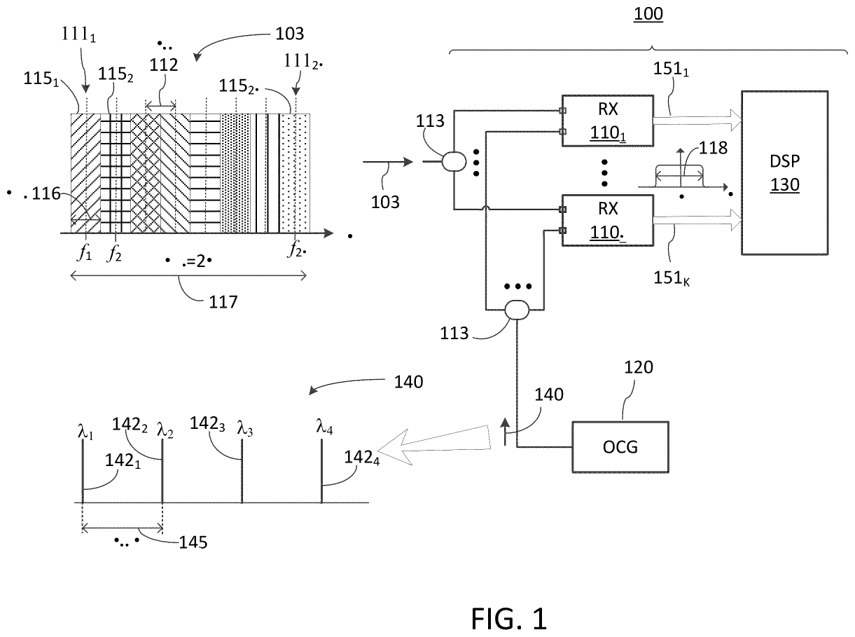

FIG. 1 schematically illustrates an optical data receiver 100 according to an example embodiment. The optical data receiver 100 is configured to receive a subcarrier-modulated (SCM) optical signal 103 comprising a sequence of 2N modulated subcarriers 115₁, . . . , 115_{2N} (“modulated subcarriers 115ₙ”), N≥1. Other embodiments may have an odd number of modulated subcarriers. The modulated subcarriers 115ₙ, n=1, . . . , 2N are schematically illustrated in FIG. 1 for N=4 as differently shaded frequency bins aligned along a horizontal frequency axis. The modulated subcarriers 115₁, . . . , 115_{2N} together occupy a total spectral bandwidth 117 Wₜ=2B, and may form a super-channel of the spectral width Wₜ=2B. The modulated subcarriers 115₁, . . . , 115_{2N} are optical frequency tones 111₁, . . . , 111_{2N} (“subcarrier tones 111ₙ”) modulated by corresponding modulation signals Fₙ(t), n=1, . . . , 2N. The subcarrier tones 111₁, . . . , 111_{2N} are narrow-band, typically cw, optical signals centered at corresponding frequencies f₁, f₂, . . . , f_{2N}. The subcarrier tones 111₁, . . . , 111_{2N} are typically approximately evenly spaced in frequency with a subcarrier frequency spacing 112 f_{SC}=B/N. The subcarriers 111₁, . . . , 111_{2N} are modulated to a bandwidth W_{c}≤B/N per subcarrier (“subcarrier bandwidth”). In the illustrated example, the subcarrier modulation bandwidth We is approximately equal to the subcarrier spacing f_{SC}=B/N for spectral efficiency. In some embodiments, the subcarrier modulation bandwidth We may be somewhat smaller than the f_{SC} 112 (FIG. 6). In some embodiments, different modulated subcarriers may have different bandwidth.

Each of the modulation signals Fₙ(t), n=1, . . . , 2N, encode a corresponding data stream. In some embodiments, these data streams may be parts of a higher-rate data signal. In some embodiments, these data streams may include information indicating how said data streams are to be assembled at the receiver 100. E.g. the data streams of the modulated subcarriers 115n may include preambles indicating a sequence or permutation order of respective data streams in the higher-rate data signal being transmitted, e.g. as integer numbers from 1 to 2N.

The optical receiver 100 includes a plurality of K≥2 optical-to-electrical (OE) converters 110₁, . . . , 110_{K}, an optical comb generator (OCG) 120, and a digital signal processor (DSP) 130. Each of the OE converters 110ₖ, k=1, . . . , K, is configured to receive a part of the received optical signal 103 at a signal input thereof, and mix it with light 140 generated by the OCG 120 (“OCG light 140”). The signal parts received by the OE converters 110ₖ have each the same modulation as the received optical signal 103. The OCG light 140 comprises a sequence (“comb”) of optical frequency tones 142ₘ, m=1, 2, . . . , M, four of which are schematically shown in FIG. 1. In example embodiments, the optical frequency tones 142ₘ are spread over an optical frequency range exceeding the bandwidth 2B of the received optical signal 103, and are evenly spaced by a comb frequency spacing f_{LO}.

The frequency tones 142ₘ are provided to local oscillator (LO) inputs of each of the OE converters 110ₖ as a shared optical frequency reference. Two 1×K optical power splitters 113 may be used to split the received optical signal 103 and the OCG light 140 in power between the K OE converters 110.

The OCG 120 may be any suitable optical comb source configured to generate a comb of frequency tones in a target wavelength range, typically from about 1.3 μm to about 1.6 μm, e.g. in the O-band or C-band of telecommunication wavelengths, and having the tone spacing f_{LO} in a range typically from about 10 GHz to about 500 GHz. E.g., in some embodiments the OCG 120 may be embodied as a mode-locked semiconductor laser, e.g. a quantum dash mode-locked laser diode (QD MLLD); in some embodiments, the OCG 120 may be a Kerr nonlinearity comb, where a single continuous-wave (CW) laser is coupled into a microresonator to generate multiple frequency tones by four-wave mixing; in some embodiments, the OCG 120 may be an EO comb source, using electro-optical (EO) modulation of a CW laser using an RF frequency source.

The light paths from each of the optical splitters 113 to different ones of the OE converters 110 are configured to provide different time delays for the OCG light relative to the SCM light. In a preferred embodiment, the relative time delays τₖ, k=1, . . . , K are approximately evenly spread within a beat period T_{LO}=1/f_{LO} of the OCG comb signal 140 with a time delay increment T_{LO}/K, i.e. approximately as described by equation (1):

$${τ}_{k} = \frac{( k - 1 ) {T}_{L O}}{K} . \qquad ( 1 )$$

In an example embodiment, the optical signal paths to each of the OE converters 110 are matched, while the OCG signal paths to different ones of the OE converters 110ₖ differ approximately by the corresponding relative time delays τₖ, e.g. in accordance with equation (1).

In example embodiments, the OE converters 110 are dual-polarization (DP) in-phase (I) and quadrature (Q) optical receivers (“IQ receivers”) using the frequency tones 142ₘ as a common reference. Known in the art IQ optical receivers configured to receive DP IQ-modulated optical signals may be used. E.g., each of the OE converters 110 may include a DP 90° optical hybrid connected at its outputs to a balanced photodetector (PD) circuit, to provide I and Q electrical PD signals in each of the two polarization paths. The 4K electrical PD signals are digitized by analog-to-digital converters (ADCs), whose outputs are processed by the DSP 130 to recover the data streams carried by the modulated subcarriers. In other embodiments, the OE converters 110 may be single-polarization IQ optical receivers.

In the following, some of the described examples relate to embodiments with K=2, i.e. with the optical receiver 100 having two OE converters 110₁ and 110_{K=2} shown in FIG. 1; extending to embodiments with K>2 is straightforward, as also described herein.

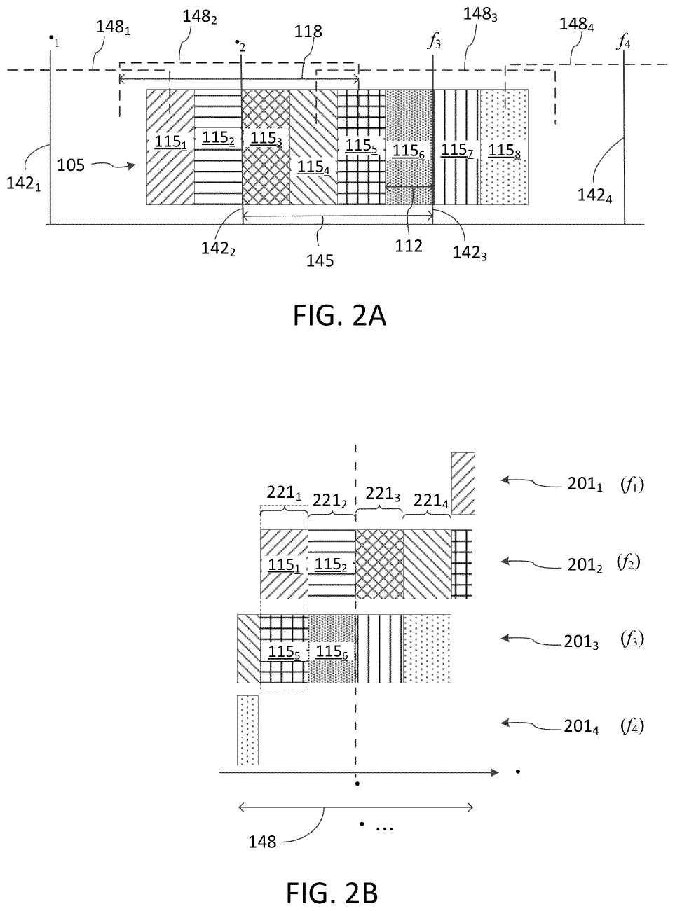

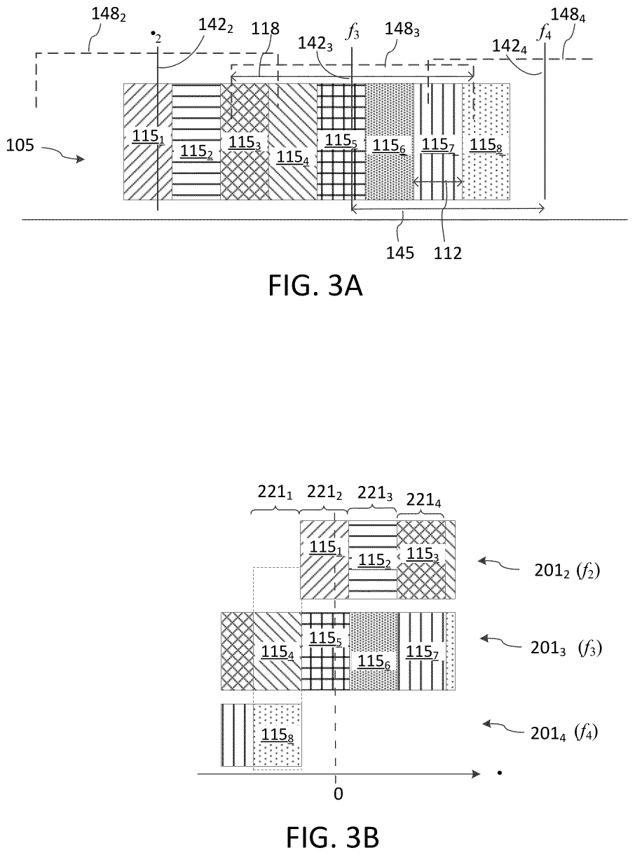

The OE converters 110ₖ are configured to down-shift different spectral portions of the received signal 103 (FIGS. 2A and 3A, spectral portions outlined by dashed lines 148) to an optical detection bandwidth 118 W_{RXO} of the OE converter by mixing (“sampling”) said portions with adjacent ones of the OCG tones 142ₘ, and to convert the down-shifted portions to electrical domain. Each of the OE converters 110ₖ outputs a temporal sequence of measurements of the received optical signal 103 in the form of digital electrical signals 151ₖ, wherein the down-converted portions of the received optical signal 103 sampled by different ones of the OCG tones 142ₘ spectrally overlap.

In some embodiments, the number K of the OE converters 110ₖ in the optical receiver 100 is such that their aggregate optical detection bandwidths, K·W_{RXO}, is at least equal to or, preferably, somewhat exceeds the bandwidth Wₜ=2B of the received SCM signal 103. In some embodiments, the optical detection bandwidth 118 W_{RXO} of each of the OE converters is selected to be at least equal to or, preferably, somewhat exceeds the bandwidth Wₜ=2B of the received SCM signal 103 divided by the number K of the OE converters 110:

$${W}_{R X O} = 2 B / K + Δ W \qquad ( 2 )$$

where ΔW is an excess bandwidth to accommodate a frequency drift of the OCG comb signal 140 relative to the SCM signal 103. The optical detection bandwidth W_{RXO} 118 preferably exceeds somewhat the OCG tone spacing 145 f_{LO}. In some preferred embodiments, the excess bandwidth ΔW≅f_{SC}, such that the Rx optical bandwidth W_{RXO} 118 covers one K-th fraction of the SCM spectrum 105, plus one additional modulated subcarrier 115:

$${W}_{R X O} ≅ 2 B / K + {f}_{S C} , \qquad ( 3 )$$

For embodiments with two OE converters 110, i.e. K=2, the optical detection bandwidth 118 may be expressed by equation (4):

$${W}_{RXO} = ( 1 + β ) \qquad ( 4 )$$

where parameter β is an “excess bandwidth” factor of the OE converter. To cover one additional modulated subcarrier 115ₙ, β should be approximately equal to K/2N, so that for K=2

$${W}_{RXO} = ( 1 + 1 / N ) \cdot B = B + {f}_{SC} , \qquad ( 5 )$$

and the optical detection bandwidth 118 of each of the OE converters 110 covers (N+1) modulated subcarriers 115.

In some embodiments, the optical detection bandwidth 118 W_{RXO} of the OE converters may exceed the value given by equation (3), or equation (5) for K=2, at the expense of lower bandwidth efficiency. For values of the excess bandwidth smaller than f_{SC}, some of the subcarriers 115 may not be detected intactly by one tone 142. Such subcarriers may be detected partially by two tones 142, which requires spectrum stitching, as explained below, to combine the two parts as an intact subcarrier.

According to the Nyquist theorem, the minimum electrical receiver bandwidth W_{RXE} of each of the OE converters 110 is one half of the optical detection bandwidth 118, i.e. W_{RXE}≥W_{RXO}/2, or for K=2

$${W}_{RXE} \geq ( 1 + 1 / N ) \cdot B / 2 \qquad ( 6 )$$

E.g., in some embodiments the OE converters 110 may use ADCs with a sampling rate equal to the optical detection bandwidth W_{RXO}. In some embodiments, the DSP 130 may be configured to digitally filter the digitized electrical signals 151ₖ with a low-pass filter having the desired electrical Rx bandwidth, e.g. as given by the right-hand sided of equation (6) for K=2.

The digital electrical signals 151ₖ from each of the OE converters 110ₖ are provided to the DSP 130 for multi-input multi-output (MIMO) processing to demodulate the data streams carried by each of the modulated subcarriers 115ₙ. The processing may include using a MIMO equalization algorithm, e.g. with multiple instances thereof executed in parallel, to separately demodulate the data streams carried by different subsets of two or more of the modulated subcarriers 115n based on the electrical outputs 151ₖ of two or more of the OE converters 110ₖ.

The MIMO equalization algorithm may be as used in coherent optical receivers to separate polarization tributaries of polarization-multiplexed signals, or may be a straightforward extension of those MIMO equalization algorithms to a bigger input/output dimension. In some embodiments, the DSP 130 includes a 2M×2M MIMO equalizer configured to use outputs of M≥2 of the OE converters 110ₖ to de-multiplex polarization tributaries of the receiver optical signal 103 and demodulate M subcarrier signals carried by said tributaries, the M subcarrier signals being a subset of the modulated subcarriers 115ₙ that are down-converted to a same frequency passband (e.g. 221ₙ, FIG. 2B or 3B) by the mixing with different OCG tones 142ₘ. MIMO equalizers typically used in DSPs of coherent DP optical receivers for polarization de-multiplexing may be configured to perform this function.

In some embodiments, the optical data receiver 100 is configured so that different subsets of the modulated subcarriers 115n contribute into different non-overlapping or weakly overlapping slices of a detected signal spectrum obtained by the DSP 130 for each of the OE converters 110ₖ. In such embodiments, the DSP 130 is configured to identify the locations of said slices (“passbands”) in a signal spectrum obtained for each of the OE converters 110ₖ, and to use the MIMO equalization to separately demodulate the data streams carried by the modulated subcarriers 115ₙ of each of the subsets based on the output signals of the two or more of the OE converters.

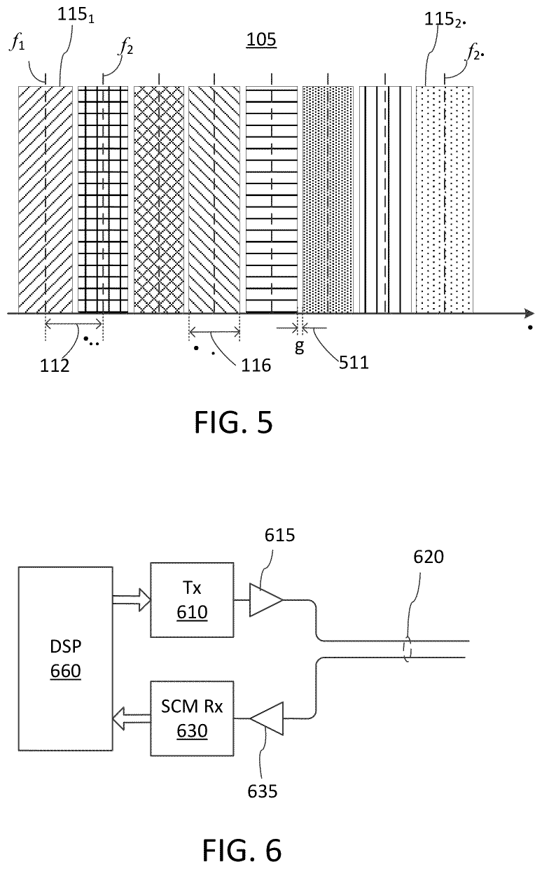

FIGS. 2A and 3A illustrate two example alignments of four frequency tones 142ₘ, m=1, . . . , 4, of the optical comb signal 140 relative to the SCM optical signal spectrum 105. In the illustrated examples, the frequency tone spacing 145 f_{LO} of the OCG light 140 is selected to be approximately equal to an integer multiple of the subcarrier spacing 112 f_{SC}=B/N of the optical SCM signal 103:

$${f}_{L O} = m \cdot {f}_{SC} , \qquad ( 6 )$$

where m is an integer greater than 1. “Approximately” here means that the spacing 145 f_{LO} may deviate from the value given by the right-hand side (RHS) of equation (6), with the deviation preferably being within a subcarrier gap 511 (FIG. 5) times m, or within +\−10% of the RHS of eq. 6 in some embodiments. As described below with reference to FIGS. 2B and 3B, having the frequency tone spacing 145 f_{LO} to be approximately equal to an integer multiple of the subcarrier spacing 112 f_{SC} may align the down-converted products of mixing of different modulated subcarriers 115ₙ with different ones of the tones 142ₖ in the detected signal spectrum. Advantageously, this alignment enables demodulating the data signals carried by the modulated subcarriers 115ₙ without requiring digital spectral stitching. In the absence of such alignment, which is preferred but not necessary, the data signals carried by the modulated subcarriers 115ₙ may still be de-modulated following approaches described herein and using digital spectral stitching.

In the example of FIG. 2A, the two middle frequency tones 142₂ and 142₃ are symmetrically located at opposite sides of a center wavelength of the SCM spectrum 105. With the comb spacing 145 being an integer multiple of the subcarrier spacing 112, the frequency tones 142₂ (optical frequency f₂) and 142₃ (optical frequency f₃) are aligned with inter-subcarrier boundaries in the SCM spectrum 105, e.g. the boundary between modulated subcarriers 115₂ and 115₃, and the boundary between modulated subcarriers 115₆ and 115₇, respectively. In the example of FIG. 3A, the two middle tones 142₂ and 142₃ are shifted by 1.2 subcarrier spacing f_{SC} 112 relative to the symmetrical alignment of FIG. 2A, as an example of OCG frequency drift. In this case, the frequency tones 142₂ and 142₃ are no longer aligned with any of the modulated subcarriers boundaries. Nevertheless, different ones of the modulated subcarriers are still spectrally aligned, pair-wise in this example, in the down-converted spectrum (FIG. 3B).

The OCG tone spacing 145 of the comb may also be approximately equal to the total optical bandwidth Wₜ=2B of the SCM signal 103 divided by the number of coherent receivers K:

$${f}_{L O} ≅ {W}_{t} / K = 2 B / K , \qquad ( 7 )$$

e.g. f_{LO}=B for K=2. In embodiments where Wₜ/K is not an integer multiple of f_{SC}, f_{LO}=┌Wₜ/(K·f_{SC})┐·f_{SC}, where ┌a┐ denotes a smallest integer that is bigger than a (ceiling of a).

Each of the OE converters 110 down-convert (in frequency) mixing products of the SCM spectrum 105 with each of the four frequency tones 142 within the optical detection bandwidth 118 W_{RXO}; in FIGS. 2A and 3A, the corresponding detection frequency bands for each of the four frequency tones 142ₘ are indicated with dashed lines 148ₘ. Typically, each of the OE converters 110 is an IQ optical receiver, which performs in-phase (I) and quadrature (Q) measurements of the mixing products and outputs temporal sequences of the I and Q measurements (streams of “I” and “Q” signal samples) as digital electrical signals 151ₖ. The DSP 130 processes these streams, e.g. as typically done in conventional optical IQ receivers, to form a complex digital signal. This complex digital signal (or two complex signals for DP IQ receivers) has a spectrum in the baseband that is centered at DC (zero frequency), as may be computed, e.g. using FFT processing.

FIGS. 2B and 3B schematically illustrate the spectra of the corresponding down-converted signals 201₁, . . . , 201₄ versus frequency f corresponding to the OCG comb alignments of FIGS. 2A and 2B, respectively. Spectra 201ₘ, m=1, 2, 3, or 4, are approximately portions of the spectrum 105 of the SCM optical signal 103, outlined by corresponding passbands 148ₘ of width W_{RXO} 118, down-converted to baseband by mixing with corresponding ones of the OCG tones 142ₘ. The spectra 201₁, . . . , 201₄ are shown as being vertically offset for clarity, but overlap within same signal streams in corresponding frequency ranges, e.g. 221₁ to 221₄. Same shading in FIGS. 2A, 2B, 3A, and 3B indicate same modulated subcarriers 115ₙ. Different subsets of the modulated subcarriers 115ₙ (different pairs, in this example) are down-converted into different ones of the frequency ranges 221ₘ, m=1, . . . , 4 (“passbands 221ₘ”). By way of example, for the OCG tone alignment of FIGS. 2A and 2B, a frequency range 221₁ includes an additive superposition of the down-shifted spectra of the modulated subcarriers 115₁ and 115₅ with no or little contribution from other modulated subcarriers. For the alignment of FIGS. 3A and 3B, a slice of the detected electrical signal within a (somewhat shifted) frequency range 221₁ (FIG. 3B) includes an additive superposition of down-converted spectra of another pair of the modulated subcarriers, 115₄ and 115₈ in this example, with no or little contribution from other modulated subcarriers. Once an offset of the frequency tones 142 relative to a center of the SCM spectrum 105 is determined, the frequency ranges 221ₘ of overlapped subcarriers may be identified, and corresponding superimposed subcarrier signals extracted by pass-band filtering (“spectral slicing”) within the detected frequency ranges (“passbands”) 221ₘ. The subcarrier modulation signals of each of the overlapping subcarriers of the subset may then be separated based on the corresponding signals obtained from the outputs 151 of the two different OE converters 110, using MIMO equalization. In the illustrated example, each of the passbands 221ₘ includes overlapping spectra of two of the modulated subcarriers; in embodiments where K>2 OE converters 110ₖ is used to down-convert all the modulated subcarriers of the received optical signal 103, K modulated subcarrier signals may be down-converted to one of the passbands 221ₘ.

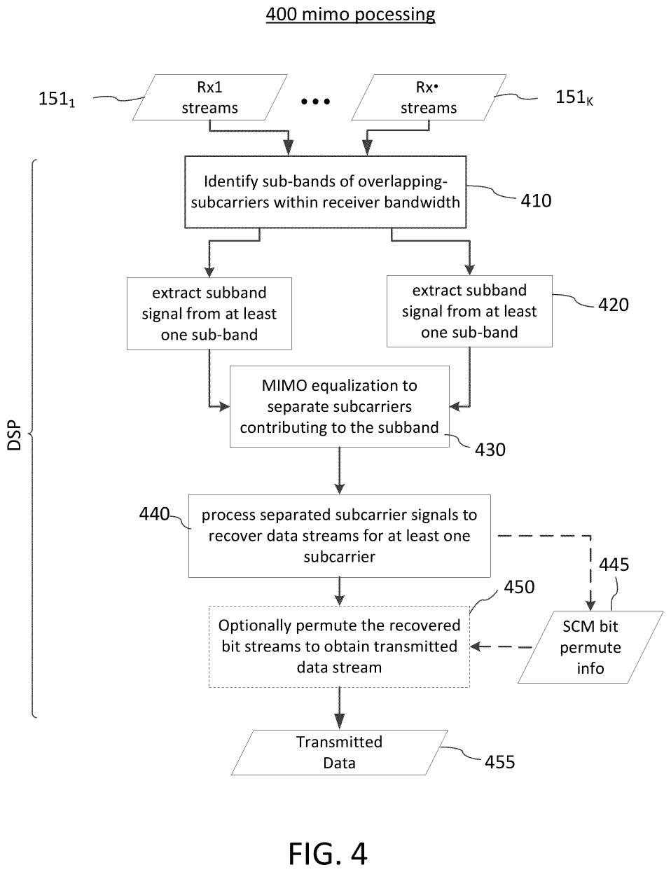

FIG. 4 illustrates example signal processing blocks of MIMO signal processing 400 that may be implemented by the DSP 130 to recover the data streams carried by the modulated subcarriers 115ₙ from the output signal streams 151₁, . . . , 151ₖ of the OE converters. In the example described below, the optical receiver 100 includes two OE converters 110ₖ, i.e. K=2, each of which being a DP IQ optical receiver. An extension to embodiments with K>2, and/or to receivers without polarization demultiplexing, will be evident to a skilled reader based on the present description.

In the example embodiment, the DSP 130 receives two digital signal streams 151₁ and 151_{K=2}, each of which including two pairs of digital IQ signals, one IQ signal pair for each of two orthogonal polarization tributaries of the received SCM optical signal 103. The DSP 130 may be configured to combine the I and Q signal streams for each of the polarizations into a single complex signal stream C_{X(Y)}(tᵢ)=(I_{X(Y)}(tᵢ)+j·Q_{X(Y)}(tᵢ), where tᵢ denotes sampling times and j=√(−1), and the subscripts “X” and “Y” denote the two polarization tributaries; here the expression “X(Y)” indicates one of “X” or “Y”. The DSP 130 may perform various signal conditioning operations on the received digital signals 151ₖ or on the complex signal stream C_{X,Y}(tᵢ), including but not limited to re-timing and/or chromatic dispersion compensation, as known in the art.

At block 410, the DSP 130 processes the digital signal streams 151₁ and 151₂, or the complex signal streams C_{X(Y)}(tᵢ) obtained therefrom, to identify the frequency ranges (“subbands”), e.g. 221₁-221₄, wherein different subsets of the modulated subcarriers 115ₙ overlap. This may include estimating a frequency offset f offset of one of the OCG tones 142ₘ from a center of the signal spectrum 105; here known methods of LO frequency offset estimation may be used; e.g. a fourth-power estimator, or a phase increment estimator, or any other suitable frequency offset estimator. The boundaries of the frequency ranges 221ₘ may then be estimated based on the estimated frequency offset f offset and the subcarrier spacing f_{SC}, e.g. as f_{offset}(m)=(f_{offset}±m·f_{SC}), where m=1, . . . , for an even number of modulated subcarriers in the SCM signal 103.

At block 420, the DSP 130 applies digital passband filters with frequency passbands set to the subbands identified at 410, e.g. the subbands 221ₘ (FIGS. 2B and 3B) to extract corresponding passband signals Sₘ(t), m=1, . . . , M, each of the Sₘ(t) comprising a linear superposition of a pair (or, generally, up to K) of the modulated subcarriers 115ₙ with subcarrier indices of the corresponding pairs m and m+l. In the described example with 2N=8 modulated subcarriers, l=f_{LO}/f_{SC}=4. (FIGS. 2B, 3B). The passband filtering may include slicing the detected signal spectrum at frequencies f_{offset}(m) defining the boundaries of the subbands 221ₘ. The passband signals Sₘ(t) may then be down-converted to the baseband.

In the example embodiments where the OE converters 110ₖ are DP IQ optical receivers, the passband signal Sₘ(t) is extracted separately for each of the two polarization tributaries for each of the EO converters 110ₖ, resulting in 2·K=4 signals S_{m,k,P}(t) for each subset (pair) of the overlapping subcarriers (each passband 221ₘ); here the subscript k=1, 2 denotes one of the EO converters 110ₖ, and the subscript “P” refers to one of the two polarization tributaries being de-multiplexed, commonly denoted as “X” and “Y”.

At block 430, modulation signals for a first pair of subcarriers, e.g. 115₄ and 115₈, are extracted by applying a 4×4 MIMO equalizer to outputs of the passband filtering in a first passband, e.g. 221₁, to the signals detected for each of the two OE converters in two polarizations. The corresponding four passband signals S_{m,k,P}(t), m=1, are passed as inputs to the 4×4 MIMO equalizer, which performs polarization de-multiplexing and separation of the subcarrier modulation signals for the two overlapped subcarriers, e.g. 115₄ and 115₈ (FIG. 3B). Subcarrier modulation signals for a second pair of subcarriers, e.g. 115₁ and 115₅, may be extracted by applying a second instance of the 4×4 MIMO equalizer to respective outputs of the passband filtering for a second passband, e.g. 221₂ in the example of FIG. 3B. The MIMO processing at block 430 may be performed for all M=4 subsets (pairs in the described example) of the overlapping subcarriers, e.g. by applying it, e.g. in parallel, to outputs of the passband filtering in the M=4 passbands 221ₘ at block 420. The MIMO equalizer used in block 430 may be configured to simultaneously separate the transmitted polarizations and the subcarrier modulation signals of the overlapped subcarriers for each of the transmitted polarizations. The DSP 130 may use MIMO equalization techniques known in the art to automatically track channel/transceiver dynamics, including but not limited to polarization variations in the fiber link, potential phase mismatch among the modulated subcarriers 115ₙ, e.g. in embodiments wherein the subcarriers are combined in a SCM superchannel at the optical transmitter 110.

At block 440, the DSP 130 may process one or more of the separated subcarrier signals to recover the data streams carried by each, or at least one, of the subcarriers. In some embodiments, e.g. wherein same data streams are carried by corresponding subcarriers in both polarizations of the SCM optical signal 103, the DSP may first combine the corresponding subcarrier modulation signals obtained for the two polarizations into one subcarrier signal. The subcarrier signals may then be de-modulated to recover the corresponding transmitter-generated data streams carried by each, or at least one, of the subcarriers. In some embodiments, the DSP 130 may output one or more of the recovered subcarrier data streams as transmitted data 455. In some embodiments, the DSP 130 may process the data streams to extract information 445, e.g. from preambles thereof, indicating how the recovered subcarrier data streams are to be combined at block 450 to recover the transmitted data 455.

The DSP 130 may perform various signal processing operations other than those described above, such as those typically performed by a DSP of conventional DP IQ optical receivers. Such operations may include, but are not limited to, time recovery, fiber impairments compensation, equalizations (other than the MIMO) of the received signal streams, carrier frequency/phase recovery, and various decoding operations on recovered bit streams, such as e.g. forward error correction (FEC) decoding.

In embodiments where the OCG tone spacing f_{LO} is intended to be set according to equation (6), the f_{LO} may still somewhat deviate from an exact integer multiple of the subcarrier spacing f_{SC}; e.g. the f_{LO} may be synchronized to a receiver clock, while the f_{SC} may be synchronized to a transmitter clock, which may somewhat deviate from each other. In some embodiments, the subcarrier frequency mismatch may be at least partially corrected by carrier recovery processing in the DSP 130, as conventionally performed in DSPs of coherent optical receivers. E.g., the MIMO equalization block 430 may include a digital phase locked loop (PLL) to correct for the f_{SC}−f_{LO} frequency mismatch.

Deviations of the f_{LO} from an integer multiple of the f_{SC} may also result in a crosstalk between adjacent modulated subcarriers in embodiments wherein W_{c}=f_{SC}; e.g. the frequency band 221₂ in FIG. 3B, in addition to the overlapped subcarriers 115₁ and 115₅, may include contributions from one or more of the modulated subcarriers that are adjacent to one of the 115₁ and 115₅, e.g. one or more of the modulated subcarriers 115₂, 115₄, 115₆, 115₈, in the example of FIGS. 2A and 2B. In order to prevent or at least reduce this cross-talk, in some embodiments the SCM optical spectrum 105 may include gaps 511 of width g=(f_{SC}−W_{c})>0 between adjacent ones of the modulated subcarriers 115ₙ, n=1, . . . , 2N, as schematically illustrated in FIG. 5. The inter-subcarrier gap width g may be, e.g., at least equal to a maximum expected value of the clock miss-match between the optical transmitter 110 and the optical receiver 100. The inter-subcarrier gap width g 511 may be further chosen to accommodate the subcarrier frequency roll-off at the subcarrier spectral edges; such frequency roll-offs may be, e.g., due to a finite length of a digital filter shaping the modulation spectrum of the subcarrier at the transmitter. In some embodiments, the gap width g 511 is selected to be at least 10 times smaller than the signal bandwidth W_{c} of each of the modulated subcarriers, for the sake of spectral efficiency. In other embodiments, the gap width g 511 may be larger. By way of example, the subcarrier signal bandwidth We may be in a range from 1 GHz to 50 GHz, while the inter-subcarrier gap g may be in a range from 10 MHz to 1 GHz.

FIG. 6 schematically illustrates an optical transceiver 600 according to an embodiment. The optical transceiver 600 includes an optical transmitter (Tx) 610 to transmit optical signals into an optical fiber line 620, and an optical receiver (Rx) 630 to receive optical signals from the optical fiber line 620. A DSP 660 is configured to generate signals to be transmitted with the Tx 610, and to process output signals of the Rx 630. Optical amplifiers 615 and 635 may be provided to boost the optical signals received from the optical fiber line 620, and to pre-amplify signals generated by the Tx 610. The optical receiver 630 is an embodiment of the optical receiver 100 described above, i.e. is configured to down-convert received SCM optical signals using an optical comb generator as a local oscillator, and the DSP 660 configured to process the output signals of the Rx 630 as described above.

In some embodiments, e.g. when the optical transceiver 600 resides in an optical network unit (ONU) of a passive optical network (PON), the optical Tx 610 may be a single-channel transmitter. In some embodiments, e.g., wherein the optical transceiver 600 is at a node of a broadband optical network or used for high-data rate communications in a data center, the Tx 610 may be an SCM optical signal transmitter configured to generate SCM optical signals such as the SCM optical signal 103 described above. In such embodiments, the optical transmitter 660 may generate the modulated subcarriers of an SCM signal, e.g. such as the modulated subcarriers 115n of the SCM optical signal 103, by modulating, and then wavelength multiplexing, 2N light beams of corresponding optical frequencies, e.g. from 2N different light sources or an optical comb source, or by modulating light from a single cw light source with a digitally-generated electrical SCM signal, e.g. using a digital SCM (“DSCM”) method known in the art. In the wavelength-multiplexing embodiments with different light sources, the light sources do not have to be phase-locked, nor their modulation synchronized. In some embodiments, the optical transmitter 610 may use one or more dual-polarization (DP) in-phase and quadrature (IQ) modulators (DP IQM) to generate the optical SCM signal, e.g. such as signal 103, with same IQ modulated subcarriers in each of two orthogonal polarizations thereof.

For high-end coherent transceivers, example embodiments described provide a multi-channel optical receiver that does not require an optical filter, DEMUX, or WSS to separate WDM channels. This may simplify integration of multiple coherent receivers, as integrating widely-tunable optical filters, e.g., to cover the full C-band, in a same chip with an Rx optical front end is non-trivial. In commercial coherent transceivers, it has been a common practice to integrate two sets of DSP on one ASIC chip to detect two wavelength channels. With a colorless optical receiver as described above, it may become possible to co-integrate a colorless multi-channel optical Rx frontend and a multi-channel DSP ASIC.

Furthermore, optical receivers such as described may be tolerant to frequency drifts of the LO comb source, and thus may not require cooling. This may be attractive for lower-cost coherent applications, such as e.g. for datacenter connectivity, where cooling power consumption has become a major concern.

For point-to-multipoint transmission applications, such as e.g. PON, using the colorless receiver as described above may allow having a free-running laser at an arbitrary wavelength, provided that the wavelength falls into the frequency range of the receiver-side OCG, which may greatly reduce the cost and power consumption of end users.

An example embodiment described above, e.g. in the summary section and with reference to any one or more of the FIGS. 1-6, provides an apparatus. The apparatus comprises an optical data receiver (e.g. 100, FIG. 1) to receive an optical signal (e.g. 103) comprising spectrally adjacent modulated subcarriers (e.g. 115₁, . . . , 115_{2N}). The optical data receiver comprises an optical comb generator (e.g. 120) to output separate frequency tones (e.g. 142₁, . . . , 142₄), a plurality of optical-to-electrical (OE) converters (e.g. 110₁, . . . , 110_{K}), and a digital signal processor (DSP) (e.g. 130, 660). Each of the plurality of OE converters is configured to mix light of a plurality of the frequency tones with part of the received optical signal and to output a temporal sequence of measurements (e.g. 151₁, 151_{K}) of the mixture produced by said mixing. The DSP configured to recover a data stream carried by one of the subcarriers (e.g. 115₁) by performing MIMO processing using the temporal sequences of measurements (e.g. 151₁, 151_{K}) output by two of the OE converters (e.g. 110₁ and 110_{K}). The MIMO processing involves performing passband filtering for a first passband (e.g. 221₁, FIG. 2B), two of the subcarriers (e.g. 115₁ and 115₅, FIG. 2B) being down-converted to the first passband by the mixing.

In some implementations, the MIMO processing involves performing passband filtering for a second passband (e.g. 221₂, FIG. 2B), two others of the subcarriers (e.g. 115₂ and 115₆, FIG. 2B) being down-converted to the second passband by the mixing. In some of such implementations, the first and second passbands may be spectrally adjacent. In some of such implementations, the first and second passbands may be separated by a gap (e.g. 511, FIG. 5).

In any of the above implementations, the DSP may be configured to recover data streams carried by at least 4 of the modulated subcarriers (e.g. 115₁, 115₂, 115₅, and 115₆); and the subcarriers (e.g. 111₁, to 111_{2N}, FIG. 1) have about the same subcarrier spectral spacing (e.g. 112, FIGS. 1 and 5).

In any of the above implementations, the frequency tones may have a tone spectral spacing, the tone spectral spacing being an integer times the subcarrier spectral spacing, the integer being greater than one.

In any of the above implementations, the DSP may be configured to perform passband filtering for a plurality of spectrally non-overlapping passbands (e.g. 221₁ to 221₄, FIGS. 2B and 3B) on signals obtained for the two of the OE converters (e.g. 110₁, 110_{K}) from the temporal sequences of measurements (e.g. 151₁, 151_{K}), different subsets of the modulated subcarriers (e.g. 115₁ and 115₅; 115₂ and 115₆; 115₃ and 115₇, 1154₃ and 115₈, FIGS. 2B and 3B) being downconverted by the mixing to different ones of the passbands, and to use MIMO equalization on outputs of the filtering to recover data signals of the subsets.

In any of the above implementations, each of the two OE converters may be a dual-polarization optical receiver, and the DSP may configured to use MIMO equalizers for polarization demultiplexing and for demultiplexing the subcarriers.

In any of the above implementations, the plurality of OE converters may include K OE converters, K≥2, and at least some of OE converters of the plurality of OE converters may have an optical detection bandwidth W_{RXO} (e.g. 118, e.g. FIGS. 1, 2A, 3A) that exceeds a ratio of a modulation bandwidth Wₜ (e.g. 117, FIG. 1) of the received optical signal (e.g. 103) to K by at least one subcarrier frequency spacing f_{CS} (e.g. 112, e.g. FIGS. 1, 5).

In any of the above implementations, the plurality of OE converters includes K OE converters, K≥2, and an optical detection bandwidth W_{RXO} of at least some of the K OE converters encompasses 1/Kₜₕ of the modulated subcarriers of the optical signal plus one.

In any of the above implementations, the optical data receiver (e.g. 100) may be configured to provide the optical signal and the light of the optical comb generator to different ones of the OE converters with relative time delays that differ by a fraction of a beat period T_{LO}=1/f_{LO} of the optical comb signal, the f_{LO} being a frequency spacing of the tones (e.g. 145, FIGS. 1, 2A, 3A). The fraction may be approximately 1/K, K≥2 being the number of the OE converters in the plurality of OE converters.

In any of the above implementations, each of the two OE converters may be an optical in-phase and quadrature (IQ) receiver. In some of such implementations, the optical IQ receivers are dual-polarization IQ receivers, and the MIMO processing comprises 4×4 MIMO equalization.

In any of the above implementations, the plurality of OE converters may comprise K dual-polarization IQ receivers, and the MIMO processing may comprise 2K×2K MIMO equalization.

In any of the above implementations, the temporal sequence of measurements (e.g. 151₁, e.g. 151_{K}) from each of the two OE converters (e.g. 110₁, e.g. 110) may comprise in-phase (I) and quadrature (Q) measurements. The MIMO processing may comprise: obtaining a complex signal from the I and Q measurements for each of the two OE converters; pass-band filtering of the complex signals for the first passband (e.g. 221₁, e.g. FIG. 2B or 3B); and performing MIMO equalization on corresponding outputs of the passband filtering for the two OE converters to recover data stream carried by the two of the subcarriers.

In any of the above implementations, each of the two OE converters may be a dual-polarization optical receiver.

In any of the above implementations, at least one OF converter from the plurality of OE converters may be a single-polarization optical receiver.

The examples described above are not intended to be limiting, and many variations will become apparent to a skilled reader having the benefit of the present disclosure. For example, different OE converters may have different optical detection bandwidths. Various embodiments may use different multicarrier modulation schemes, subcarrier modulation formats, serial-to-parallel (S/P) encoding and parallel-to-serial (P/S) decoding methods, different types of optical frequency comb generators. The optical receivers according to the present disclosure may, be configured to operate in other wavelength ranges than described above, with different numbers of OE converters in the receiver, and different types of the OE converters, and use any suitable MIMO algorithm. Furthermore in the description above, for purposes of explanation and not limitation, specific details are set forth such as particular architectures, interfaces, techniques, etc. in order to provide a thorough understanding of the present invention. In some instances, detailed descriptions of well-known devices, circuits, and methods are omitted so as not to obscure the description of the present invention with unnecessary detail. Thus, for example, it will be appreciated by those skilled in the art that block diagrams herein can represent conceptual views of illustrative circuitry embodying the principles of the technology. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Furthermore in the description above, for purposes of explanation and not limitation, specific details are set forth such as particular architectures, interfaces, techniques, etc. in order to provide a thorough understanding of the present invention. In some instances, detailed descriptions of well-known devices, circuits, and methods are omitted so as not to obscure the description of the present invention with unnecessary detail. Thus, for example, it will be appreciated by those skilled in the art that block diagrams herein can represent conceptual views of illustrative circuitry embodying the principles of the technology. All statements herein reciting principles, aspects, and embodiments of the invention, as well as specific examples thereof, are intended to encompass both structural and functional equivalents thereof.

Thus, while the present invention has been particularly shown and described with reference to example embodiments as illustrated in the drawing, it will be understood by one skilled in the art that various changes in detail may be affected therein without departing from the spirit and scope of the invention as defined by the claims.

We claim:

1. An apparatus, comprising:
an optical data receiver to receive an optical signal comprising spectrally adjacent modulated subcarriers, the optical data receiver comprising:
an optical comb generator to output separate frequency tones;
a plurality of optical-to-electrical (OE) converters, each of the OE converters configured to mix light of a plurality of the frequency tones with part of the received optical signal and to output a temporal sequence of measurements of the mixture produced by said mixing;
a digital signal processor (DSP) configured to recover a data stream carried by one of the subcarriers by performing multi-input multi-output (MIMO) processing using the temporal sequences of measurements output by two of the OE converters,
wherein the MIMO processing involves performing passband filtering for a first passband, two of the modulated subcarriers being down-converted to the first passband by the mixing.

2. The apparatus of claim 1, wherein the MIMO processing involves performing passband filtering for a second passband, two others of the modulated subcarriers being down-converted to the second passband by the mixing.

3. The apparatus of claim 2, wherein the first and second passbands are spectrally adjacent.

4. The apparatus of claim 3, wherein the first and second passbands are separated by a gap.

5. The apparatus of claim 1, wherein the DSP is configured to recover data streams carried by at least 4 of the subcarriers; and wherein the subcarriers have about the same subcarrier spectral spacing.

6. The apparatus of claim 5, wherein at least two of the frequency tones have a tone spectral spacing, the tone spectral spacing being an integer times the subcarrier spectral spacing, the integer being greater than one.

7. The apparatus of claim 6 wherein the DSP is configured to perform passband filtering for a plurality of spectrally non-overlapping passbands on signals obtained for the two of the OE converters from the temporal sequences of measurements, different subsets of the modulated subcarriers being downconverted by the mixing to different ones of the passbands, and to use MIMO equalization on outputs of the filtering to recover data signals of the subsets.

8. The apparatus of claim 1 wherein each of the two OE converters is a dual-polarization optical receiver, and wherein the DSP is configured to use a same MIMO equalizer for polarization demultiplexing and subcarrier demodulation.

9. The apparatus of claim 1 wherein the plurality of OE converters includes K OE converters, K≥2, and wherein at least some of OE converters of the plurality of OE converters have an optical detection bandwidth W_{RXO} that exceeds a ratio of a modulation bandwidth Wₜ of the received optical signal to K by at least one subcarrier frequency spacing f_{CS}.

10. The apparatus of claim 1 wherein the plurality of OE converters includes K OE converters, K≥2, and wherein an optical detection bandwidth W_{RXO} of at least some of the K OE converters encompasses 1/Kₜₕ of the modulated subcarriers of the optical signal plus one.

11. The apparatus of claim 1 configured to provide the optical signal and the light of the optical comb generator to different ones of the OE converters with corresponding relative time delays, wherein consecutive ones of the relative time delays differ by a fraction of a beat period T_{LO}=1/f_{LO} of the optical comb signal, the f_{LO} being a frequency spacing of the tones.

12. The apparatus of claim 11 wherein the fraction is 1/K, K≥2 being the number of the OE converters in the plurality of OE converters.

13. The apparatus of claim 1, wherein each of the two OE converters is an optical in-phase and quadrature (IQ) receiver.

14. The apparatus of claim 13 wherein each of the optical IQ receivers is a dual-polarization IQ receiver, and wherein the MIMO processing comprises 4×4 MIMO equalization.

15. The apparatus of claim 1 wherein the plurality of OE converters comprises K dual-polarization IQ receiver, and wherein the MIMO processing comprises 2K×2K MIMO equalization.

16. The apparatus of claim 1 wherein the temporal sequence of measurements from each of the two OE converters comprises in-phase (I) and quadrature (Q) measurements, wherein the MIMO processing comprises:
obtaining a complex signal from the I and Q measurements for each of the two OE converters;
pass-band filtering of the complex signals for the first passband; and
performing MIMO equalization on corresponding outputs of the passband filtering for the two OE converters to recover data stream carried by the two of the subcarriers.

17. The apparatus of claim 16 wherein each of the two OE converters is a dual-polarization optical receiver, and wherein the MIMO equalization comprises performing polarization de-multiplexing simultaneously with recovering the data streams carried by the two subcarriers.
